(19) United States
(12) Patent Application Publication
(10) Pub. No.: US 2009/0089154 A1
(43) Pub. Date: Apr. 2, 2009

(54) System, method and computer product for implementing a 360 degree critical evaluator

(76) Inventor: Kenneth W. Dion, Austin, TX (US)

Correspondence Address: Michael T. Perkins, 902 McPhaul St., Austin, TX, 78758, US

(21) Appl. No.: 12/214,185

(22) Filed: Jun. 16, 2008

Related U.S. Application Data
(60) Provisional application No. 60/995,807, filed on Sep. 29, 2007.

(51) Int. Cl. G06Q 10/00

(52) U.S. Cl. 705/11

(57) ABSTRACT

A web-based full-cycle 360 degree (manager, peer and employee feedback) employee performance evaluation and management system and method based on organization-defined standards of behavior, job specific criteria, self review, peer feedback, and dotted line supervisor input. Standardizes evaluations for shared efforts and matrix type management situations. Evaluations include all aspects of the evaluated requirements in the employee assessment such as: job knowledge, accomplishment of objectives, quality of work, productivity, initiative and creativity, interpersonal relationships, supervisory skills, dependability and professional contribution. Manages delivery and tracking of employee performance and identifies educational and professional development needs. Provides a comprehensive record of skills and abilities that could benefit the organization and might otherwise not be noticed or recognized. Assembles data to assist with planning personnel moves and placements that will best utilize each employee's demonstrated capabilities. Customizable template-based evaluation layouts facilitate review entry forms and final printed format that matches an organization's standards of presentation. Manages performance consistency with trend analysis and out-of-bound exception reporting. Evaluates organizational performance on measured standards of excellence and environment. Delivers automated email reminders to staff and managers about pending evaluations. Provides for summary record of compliance for accreditation and certification agencies.

### RELATED APPLICATIONS

System and method for organizational and personal portfolios by Kenneth W. Dion application Ser. No. 11/542,839, dtd. 10/04/2006, System and method for implementing critical checklists by Kenneth W. Dion application Ser. No. 11/712,114, dtd. Feb. 28, 2007, Method and system for educational compliance and competency management by Kenneth W. Dion application Ser. No. 11/821,405, dtd. Jun. 22, 2007, System and method for dynamic staff bidding by Kenneth W. Dion application Ser. No. 11/888,159, dtd. Jul. 31, 2007

### FEDERALLY SPONSORED RESEARCH

No

### SEQUENCE LISTING OR PROGRAM

No

### BACKGROUND

1. Technical Field of Invention

This invention relates to data processing and more particularly to such a processing analysis with job performance evaluating the efficiency and productivity of an employee within an organization for performance improvement and regulatory compliance.

2. Background of the Invention

As society evolves industrial manufacturing and service providers have consolidated to take advantage of the economies of scale that can be realized when purchasing is done in volume. While there are many advantages to this approach a sizable distracter to efficient operation in consolidated organizations is often personnel evaluation and management. Especially in the services industry the person performing the service determines if the organization is able to perform effectively and consistently. In many industries monitoring and regulatory requirements are now in place either by self regulation or government sponsored bodies. Organizations are competing with not only other organizations but must evaluate employee performance in a timely, comprehensive, fair, and consistent manner. In the past evaluation compliance has been accomplished with a collection of clerks and some patched together data culling programs to categorize performance data. A sample of representative historical approaches follows. In U.S. Pat. No. 5,706,452 by Ivanov titled “Method and apparatus for structuring and managing the participatory evaluation of documents by a plurality of reviewers”, Ivanov discloses a method for structuring the process of pairticipatory document evaluation by a plurality of reviewers utilizing a feed-forward synchronization schema defined as a workflow graph construct. While Ivanov may have disclosed a method for managing document review his disclosure does not implement a web-based employee performance evaluation and management system based on an organizations-defined standards for evaluating professional performance in an organization for regulatory requirements with industry standard data formats. In U.S. Pat. No. 6,321,206 by Honarvar titled “Decision management system for creating strategies to control movement of clients across categories”, Honarvar discloses a software-based decision management system that allows an organization to monitor and evaluate client performance data relating to client interactions with the organization, and to appropriately modify organizational strategies in accordance with the performance data. While Honarvar may have a system for tracking client movement his disclosure does not implement a web-based employee performance evaluation and management system based on an organizations-defined standards for evaluating professional performance in an organization for regulatory requirements with industry standard data formats. In U.S. Pat. No. 6,581,037 by Pak titled “system and method for analyzing human behavior”, Pak discloses systems and methods for understanding human interactive behavior and its interpretation are provided. While Pak may have disclosed culture interpretation methods his disclosure does not implement a web-based employee performance evaluation and management system based on an organizations-defined standards for evaluating professional performance in an organization for regulatory requirements with industry standard data formats. In U.S. Pat. No. 6,615,182 by Powers et al. titled “System and method for defining the organizational structure of an enterprise in a performance evaluation system”, Powers discloses a system where an organizational structure of an enterprise is defined in a performance evaluation system by storing a plurality of user-defined levels. While Powers has added to his evaluation techniques with this disclosure his disclosure does not implement a web-based employee performance evaluation and management system based on an organizations-defined standards for evaluating professional performance in an organization for regulatory requirements with industry standard data formats. In U.S. Pat. No. 6,754,874 by Richman titled “Computer-aided system and method for evaluating employees”, Richman discloses a computer-aided method of evaluating personnel performance. While Richman discloses evaluation form and matrix routing the disclosure does not implement a web-based employee performance evaluation and management system based on an organizations-defined standards for evaluating professional performance in an organization for regulatory requirements with industry standard data formats. In U.S. Pat. No. 7,058,560 by Arakawa titled “Performance predictive apparatus and method”, Arakawa discloses that by providing a performance metrics calculation section for calculating a predetermined performance metrics determined in advance from at least part of data from among various condition data concerning a performance evaluation model. While Arakawa may have disclosed a system eliminating human biases the disclosure does not implement a web-based employee performance evaluation and management system based on an organizations-defined standards for evaluating professional performance in an organization for regulatory requirements with industry standard data formats. In U.S. Pat. No. 7,082,404 by Calderaro et al. titled “System and method for improved matrix management of personnel planning factors”, Calderaro discloses a system and method for improved matrix management of personnel planning factors is provided. While Calderaro has disclosed a method for implementing matrix management reviews the disclosure does not implement a web-based employee performance evaluation and management system based on an organizations-defined standards for evaluating professional performance in an organization for regulatory requirements with industry standard data formats. In U.S. Pat. No. 7,280,977 by Sengir et al. titled “System and model for performance value based collaborative relationships”, Sengir discloses a model for assessing performance of a dynamic collaborative relationship. While Sengir may have disclosed techniques for reviewing collaborative relationships critical evaluations of humans has additional complexities the disclosure does not implement a web-based employee performance evaluation and management system based on an organizations-defined standards for evaluating professional performance in an organization for regulatory requirements with industry standard data formats. In US Patent Publication #20030182178 by D'Elens et al. titled “System and method for skill proficiencies acquisitions”, D'Elens discloses a system and method for skill proficiencies acquisitions. While D'Elens may have disclosed skill mapping and rating critical evaluations require expanded functionality as the disclosure does not implement a web-based employee performance evaluation and management system based on an organizations-defined standards for evaluating professional performance in an organization for regulatory requirements with industry standard data formats. In US Patent Publication #20050144022 by Evans titled “Web-based system, method, apparatus and software to manage performance securely across an extended enterprise and between entities”, Evans discloses a Web-based system, method, apparatus and software that enables capture, integration, filtration, aggregation and collaboration of corporate performance-related data from unlimited, but at least one local system, as well as manual data entry; organization of corporate performance-related data into unlimited, but at least one corporate performance-related metric. While Evans may have disclosed a set of security methods for shared evaluation the disclosure does not implement a web-based employee performance evaluation and management system based on an organizations-defined standards for evaluating professional performance in an organization for regulatory requirements with industry standard data formats. In US Patent Publication #20060241974 by Chao titled “System and method for peer-profiling individual performance”, Chao discloses a system and method for evaluating the performance of individuals or entities employed by an organization, particularly useful in peer-profiling physician performance in multi-facility environments. While Chao may have disclosed a system of peer-profiling in a specific area where a difficulty for standards exists the disclosure does not implement a web-based employee performance evaluation and management system based on an organizations-defined standards for evaluating professional performance in an organization for regulatory requirements with industry standard data formats. Combinational approaches to achieve the capabilities of the present system would suffer from architectural deficiencies and a complete rewrite of code would be necessary diminishing the original approach of the previous authors.

### SUMMARY OF THE INVENTION

To address the industrial and organizational needs in the market place the system and method for implementing a full cycle (360 degree) critical evaluator has been architected as a web-based professional performance evaluation tool. The specific industry addressed in this disclosure is for the specific requirements of organizations in the health care industry. However, the practices, systems, and methods apply to any service industry organization that employs individuals to accomplish tasks that require monitoring and evaluation for assuring performance. The stringent federal and state regulatory requirements and the subjective approach to quality evaluation in the healthcare field have resulted in the demand for a more effective way to evaluate healthcare professional's competencies. The system and method for implementing a 360 degree critical evaluator allows organizations to focus on quality improvement by concentrating on enhancing individual performance and competence in a fair, consistent, and repeatable manner, not just processes. The system and method for implementing a 360 degree critical evaluator facilitates the systematic acquisition and assessment of information with immediate availability from a wide variety of sources to provide actionable feedback to both the organization and the individual. This comprehensive collection of organization-specific evaluation criteria data facilitates tracking of staff development and career progression. The full cycle (360 degree) feature includes staff evaluations based on organization-defined standards of behavior, job-specific criteria, self review, peer feedback, and dotted line supervisor input.

The system and method for implementing a full cycle 360 degree critical evaluator benefits:
Provides web-based employee performance evaluation and management.
Eliminates existing paper-based processes,
Includes all aspects of the evaluated requirements in the employee assessment such as:
   job knowledge,
   accomplishment of objectives,
   quality of work,
   productivity,
   initiative and creativity,
   interpersonal relationships,
   supervisory skills,
   dependability, and
   professional contribution.
Support 360 degree evaluation process with manager, peer, and employee feedback,
Manages delivery and tracking of employee performance and identifies educational and professional development needs,
Provides a comprehensive record of immediately available skills and abilities that could benefit the organization and might otherwise not be noticed or recognized, and
Assembles data to assist with planning for personnel moves and placements in order to best utilize each employee's demonstrated capabilities.

Additional features of the system and method for implementing a 360 degree critical evaluator include:
delivering automated staged email reminder and preemptive alerts to staff and managers about pending evaluations,
customizable template-based evaluation layouts mean the review entry forms with organization specific set up formats and final printed format matches current organization forms or desired improvements,
Manages performance consistency for evaluators and employees with trend analysis and out-of-bound exception reporting, and
Evaluates organizational performance on measured standards of excellence and environment of care criteria.

The system and method for implementing a 360 degree critical evaluator is offered as a web-based tool. This hosted model service provides the subscribers with a lower total cost of ownership as the infrastructure hardware, data storage in an industry standard format, and software overhead and maintenance are not a concern of the individuals. This means that the sponsoring organization does not have to purchase expensive hardware on which to run the application. No additional support and maintenance is necessary, software upgrades are automatic, no third party software is required, no special applications tweaker is needed on site to keep third party applications running, downtime is never a problem with the host's redundancy hardware/software configuration, and the simple screen interfaces of the system and method for implementing a 360 degree critical evaluator improving performance, compliance, and assuring that no special operational or application individual is needed by the sponsoring organization's support staff.

### BRIEF DESCRIPTION OF THE DRAWINGS

FIG. 1 shows a functional configuration of a 360 degree critical evaluator.

FIG. 2 shows a block diagram of a 360 degree critical evaluator.

FIG. 3 shows an initial log interface screen for an authorized user of a 360 degree critical evaluator.

FIG. 4 shows a computer product interface of a 360 degree critical evaluator home page.

FIG. 5 shows a computer product interface of a 360 degree critical evaluator compliance tools menu.

FIG. 6 shows a computer product interface of a 360 degree critical evaluator manager tools menu.

FIG. 7 shows a computer product interface of a 360 degree critical evaluator personal tools menu.

FIG. 8 shows a computer product interface of a 360 degree critical evaluator reporting and analysis menu.

FIG. 9 Deleted

FIG. 10 shows a computer product interface of a 360 degree critical evaluator manage competencies menu.

FIG. 11 shows a computer product interface of a 360 degree critical evaluator manage documents and images menu.

FIG. 12 shows a computer product interface of a 360 degree critical evaluator manage evaluations menu.

FIG. 13 shows a computer product interface of a 360 degree critical evaluator manage local settings menu.

### DETAILED DESCRIPTION OF THE DRAWINGS

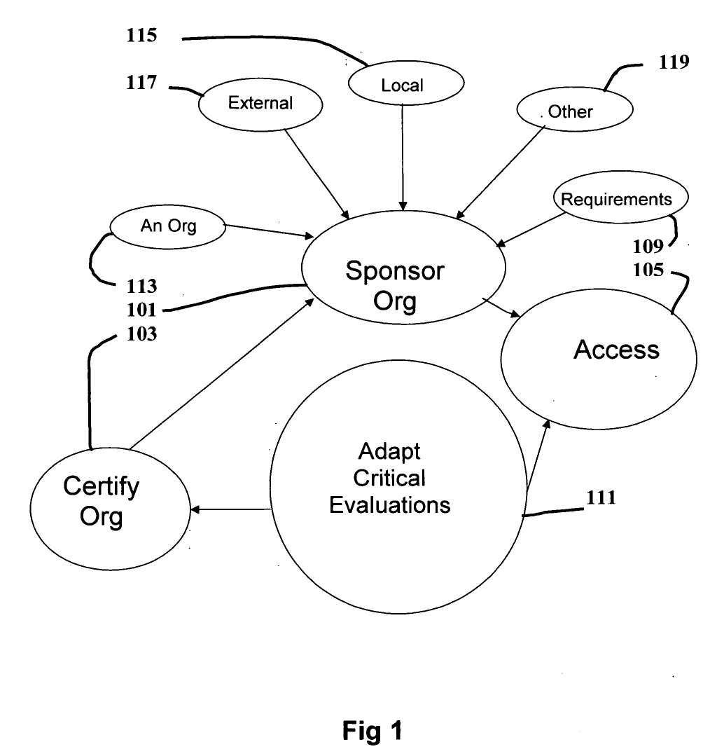

FIG. 1 shows a functional representation of a 360 degree critical evaluator. The 360 degree critical evaluator management system and method for institutions and organizations is centered on a sponsoring organization 101. The typical organization 101 using this critical evaluator system and method is characterized by having multiple staff members at various levels of functionality that are required to be trained, maintain proficiencies, assimilate new skills, be able to document the processes to assure these procedures, and submit compliance reports. The organization 101 will base their critical evaluator management system on organizational requirements and submit periodic records of compliance to a certifying organization 103. An organization 103 can be a recognized group, a government agency (state, federal, local, etc.) or a collective non-profit; there can be multiple organizations 103 that the organization 101 desires to achieve and maintain accreditation or certification with. Organization 101 will typically facilitate access 105 to employees and staff members that is selectable from employees consisting of many varied levels of functionality and organizational roles to be completed both on-line and off line as appropriate. Although the 360 critical evaluator is mainly an on line tool evaluators can print hard copies and reports to adapt to evaluation requirements and individual preferences. Organization 101 can generate their own evaluation criteria or access from another organization 113. Also the organization 101 can access an external 117 criteria for such as supporting materials, articles, and documents. Additionally, organization 101 can access a local 115 content to satisfy organizational unique requirements. Additionally, organization 101 can access an other 119 content for additional supporting materials such as content reviews, training videos, seminars, etc. Additionally, a requirements 109 are based on agreements with such as organization 103, local needs, and requirements. The organization 101 can assign multiple (administrators can define access (security and privileges) appropriate to their organization or institution) different levels of access and control to employees. These levels are such as: users, managers/supervisors, organization administrators, and system administrators. Assigning different levels of access allow organizations to limit access to specific functions through level of access. For example while users will be supplied personal results, an organization will typically only allow approved individuals such as administrators, managers, and supervisors access to evaluation results in non-summary form. Additionally, evaluation criteria, additions, deletions, and modification of are usually limited to organization approved individual such as administrators, managers, and supervisors. An adapt critical evaluations 111 allow users with access to adapt material, customizable templates, and additionally they can assign evaluations, author reports, establish requirements and manipulate content for employee evaluations that they supervise, organization administrators oversee the implementation of critical evaluations using organizational standard forms, templates, and reports, set and adjust goals, generate summary records of compliance reports, and interface to the organization 103 on behalf of the organization 101, and system administrators oversee local operation and interface to the provider of system functionality.

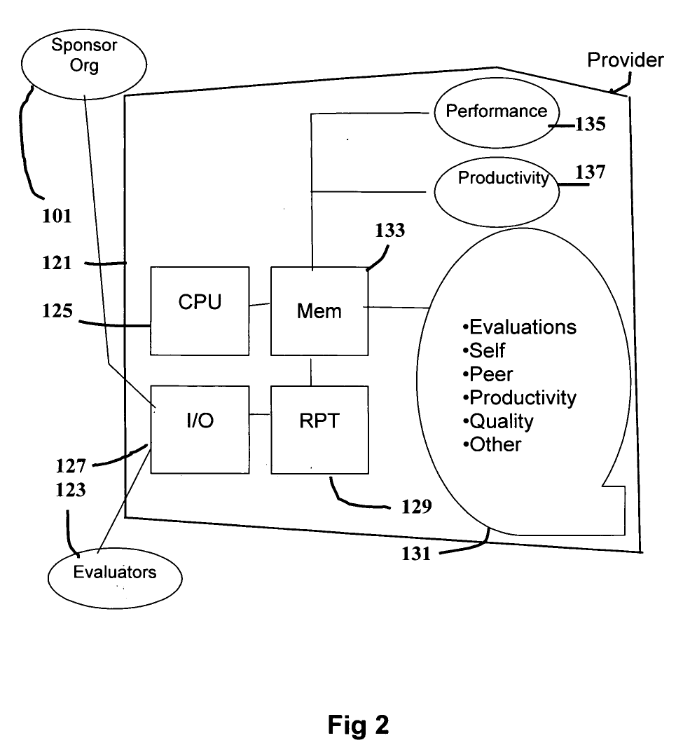

FIG. 2 shows a block diagram of a 360 degree critical evaluator. This block diagram has the processing functions of the 360 degree critical evaluator system for evaluating professional performance in an organization enclosed in a provider 121 enclosure. The provider 121 is typically at a remote location transmitting data and information to the sponsoring organization 101 and an evaluator(s) 123 computer entry interface. Evaluators can enter and interact in both an on-line and off-line (hard copy) method to accomplish critical evaluations and management functions. These connections for access by evaluators to the provider 121 processing and content delivery functions is typically over a network such as the internet with the organizations 101 and the evaluator(s) 123 providing their own browser enabled terminal or access devices. This virtual type data processing (processing power (analysis), storage, and software (program code) residency connected by network) relationship is cost effective to sponsoring organization 101. This service relationship is cost effective to the organization 101 as program updates, maintenance, networked computers, and support are calculated at rates that are shared and no internal support group is employed, distracting from the core focus of the organization 101. The provider 121 facilitates secure access to authorized remote users through a system I/O 127 port. The bandwidth, security, and privileges associated with remote users are determined with the set up assignments of the organization 101 to the provider's 121 systems administrator. Although the evaluator(s) 123 interface directly to I/O 127 the system access privileges are governed by the setup and control rules of the sponsoring organization 101. The I/O 127 access a CPU 125 for forms, customizable templates, content manipulation, loading, and evaluations. The I/O 127 is typically The CPU 125 will utilize a mem 133 for extended functions, storage, and other data operations. A storage function is represented by a disc 131 where long term storage is kept for access, manipulation, and archiving employee performance evaluations (available on-line and off-line) for operation, certification, and adhering to regulatory requirements. These data stored by the disc 131 in industry standard data format and include evaluations by all aspects of evaluated requirements including self, peer, levels of productivity based on performance, performance quality, and other relevant data to an organization's critical evaluation of employees. Also within disc 131 are forms, templates, and reports that are created, purchased, or selected by the organization 101 to standardize evaluations and establish a comprehensive record of skills, abilities, and evaluations materials. These requirements are archived on the disc 131 and provide the organization 101 with a virtual repository of all critical data records. These records, supporting information, and software are kept current in machine readable format in industry standard data format with immediate availability to the organization 101 staff by the provider 121 to assure the collection of information represented by organizational local, external, requirements, and other contribute to a series of records and critical evaluations that inform employees and accurately measure the employees' ability to comprehend the information and perform appointed tasks. Additionally, the well maintained data records provide a stable reference for future operations and development. The organization 101 establishes through access assignment which staff will be organization approved individuals allowed to add to, delete, modify, and adapt evaluative criteria to keep an organization improving and growing through improved task performance. Also interfacing to I/O 127 is a report engine 129. Report engine 129 will, through a simple computer device screen interface configure the critical evaluation report required by the individual, staff, or organization and deliver the report (virtual or hardcopy) as specified in the options on the interface screen. The data format being industry standard data format facilitates combination and submission for reporting. The provider 121 may also provide access to an organization 101 a collection of performance 135 and productivity 137 to simplify record of compliance reporting and report completeness.

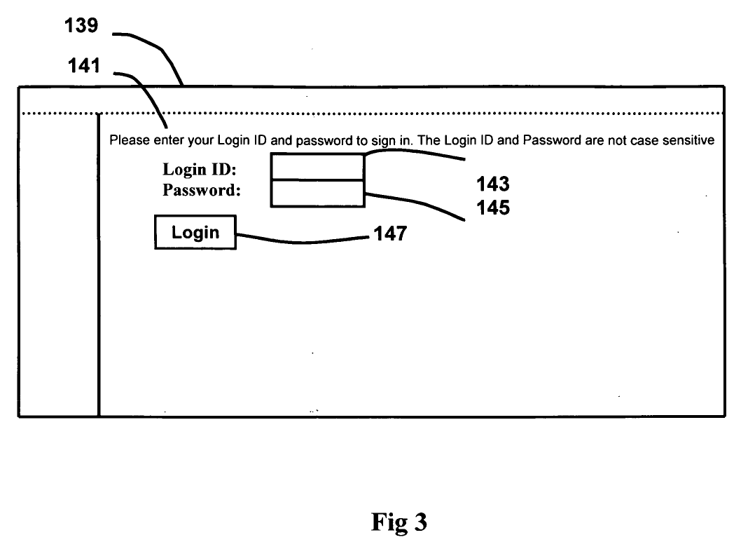

FIG. 3 shows an initial log interface screen for an authorized user for a 360 degree critical evaluator. A computer program product delivered to users is represented by an interface screen 139 which facilitates a user's log in to, the FIG. 2, provider 121 processor functions from the organization 101 connected local network. The system administrator (usually at the remote provider 121 location) has a secure initial login ID and secure password data base to be assigned to organization users. Additionally, system privileges for specific types of access to organization 101 approved individuals (by organizational role) is also assigned with varying levels of security, capabilities, and functionality by sponsoring organizations system administrator with coordination to provider 121 system administrator. Returning to FIG. 3, a user when approved by the sponsoring organization and assigned a login ID and password the user will enter login ID into a text box 143 (making note of instructions in an information line 141). A user will then enter the assigned password from sponsoring organization's system administrator into a text box 145. When the user is satisfied with the entries in box 143 and box 145 the user presses a Login button 147. When the correct login ID and password are entered correctly the user is directed to the specific critical evaluator interface screen usually set by default by the systems administrator to critical evaluator home page.

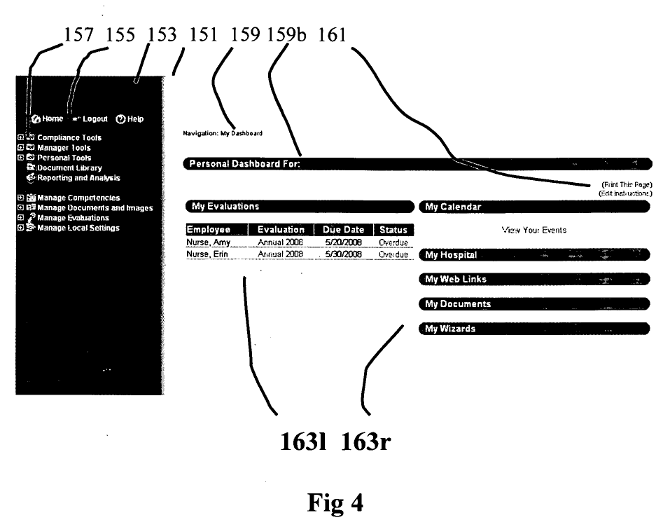

FIG. 4 shows a computer product interface of a 360 degree critical evaluator home page. A screen 151 as displayed shows a home page (also referred to as my dashboard) typically displayed after an operator has successfully secure login in from FIG. 3. Returning to FIG. 4 the screen 151 has the basic navigation instruments for an operator to operate and maintain critical evaluations for an organization. To the left of screen 151 is a navigation bar 153 featuring a header with 3 hot spots home (present screen), logout, and help. Also in bar 153 is a list of hot spots 155 an operator can select from to navigate to compliance tools, manager tools, personal tools, document library, reporting and analysis, manage users, manage competencies, manage documents and images, manage evaluations, and manage local settings. Immediately to the left of the hot spots 155 is a pair of indicators 157; leftmost indicator is the + sign (when appropriate) to indicate that multiple selection are available and to the right is the other indicator an icon indicating the entry's functionality. On the center of the screen is a welcome area 159 where the operator's “My Dashboard” from the login ID from FIG. 3 is displayed. Returning to FIG. 4 a choice of features in an area 161 allows the operator to print this page or (if the operator is authorized) edit instructions. A bar 159b below area 159 displays the personal dashboard for the logged in operator. An area 163l display the evaluations of the logged in operator with a heading “My Evaluations” with 2 upcoming evaluations with type, dates due, and status. To the right of area 163l is area 163r the displays the operator's calendar (My Calendar), My Hospital, My Web Links, My Documents, and My Wizards. The operator can select the specifics to display in addition to required events to simplify remembering scheduled necessities. These screens, forms, and templates can be edited or manipulated for evaluating professional performance in an organization by authorized staff to suit an organization's image, presentation, and how things are done for critical evaluations.

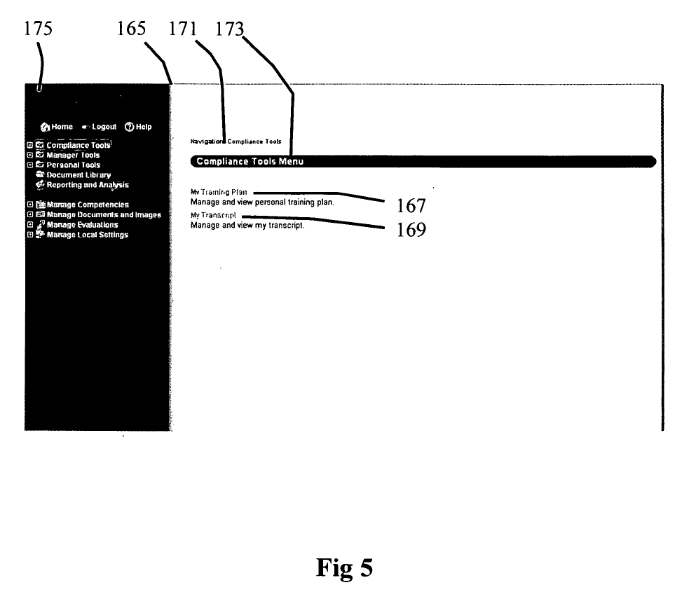

FIG. 5 shows a computer product interface of a 360 degree critical evaluator compliance tools menu. A compliance tools screen 165 is shown and is representative of a screen an operator will view when compliance tools is selected by the operator. A navigation bar 175 is displayed on the left of the screen with hot spots an operator can select from to navigate to home, logout, help, compliance tools, manager tools, personal tools, document library, reporting and analysis, manage users and profiles, manage competencies, manage documents and images, manage evaluations, and manage local settings. The screen 165 has a navigation history bar 171 for operator awareness and convenience. A title bar 173 displays the present page title “compliance tools menu”. Below bar 173 are a pair of compliance tool hot spots; my training plan 167 where an operator can manage and view individual training plans for evaluation and planning purposes. As a staff member working as an evaluator assembles information and background of an individual these tools (plan 167 and transcript 169) provide easy access to requirements and required information. A my transcript 169 is where an operator can manage and view transcripts for evaluation and planning purposes. Organization defined roles can be designed to fit established standards of an organization. By specifying how training and development are accomplished for staff within an organization performance can be improved.

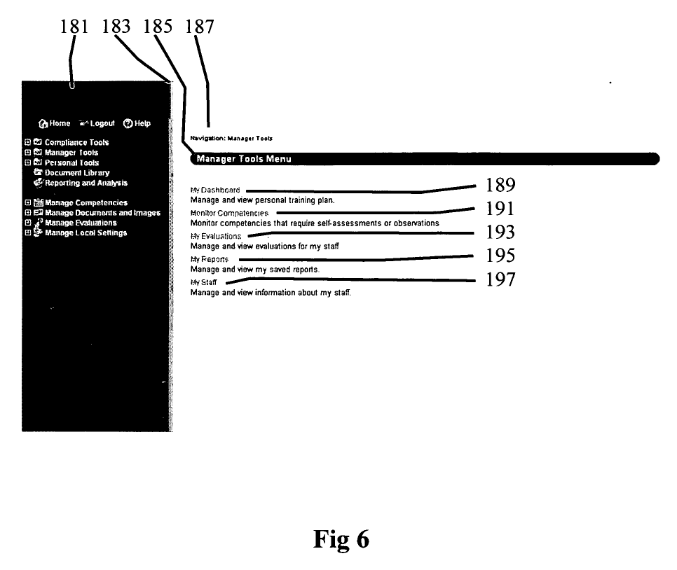

FIG. 6 shows a computer product interface of a 360 degree critical evaluator manager tools menu. A manager tools screen 183 is shown that is typically displayed when an operator selects manager tools. A bar 181 to the left displays navigation hot spots for operator navigation where an operator can manipulate evaluation forms and formats on-line and off-line through; select; home, logout, help, compliance tools, manager tools, personal tools, document library, reporting and analysis, manage users and profiles, manage competencies, manage documents and images, manage evaluations, and manage local settings. The screen 183 has a navigation history bar 187 for operator awareness and convenience. The screen 183 has a title bar 185 displaying the screen title “Manager Tools Menu”. Below the title bar 185 are a collection of operator selectable navigation hot spots with operator tools. A first hot spot 189 is labeled “My Dashboard” where an operator can manage and view personal training plans. A next hot spot 191 is labeled “Monitor Competencies” where an operator can monitor competencies that require self-assessments or observation. A next hot spot 193 is labeled “My evaluations” where an operator can manage, track, and view evaluations and establish employee grouping for standardizing group evaluations for an operator's staff. The spot 193 facilitates an organizations tracking of employee performance proficiency on-line and off-line with a streamlined availability for improved usage. A next hot spot 195 is labeled “My reports” where an operator can manage, track, and view templates, report forms, and saved reports and establish employee grouping for standardizing group evaluations reports. Operators have organization evaluations and regulatory requirements compliance presented in the organization-defined standards. A next hot spot 197 is labeled “My staff” where an operator can manage and view information, reports, and establish employee grouping for standardizing group evaluations and review or modify to suit automated reminders about an operator's staff. The spot 197 has facilities for viewing and inputting information encompassing the entire organization for full cycle (360 degree) evaluations.

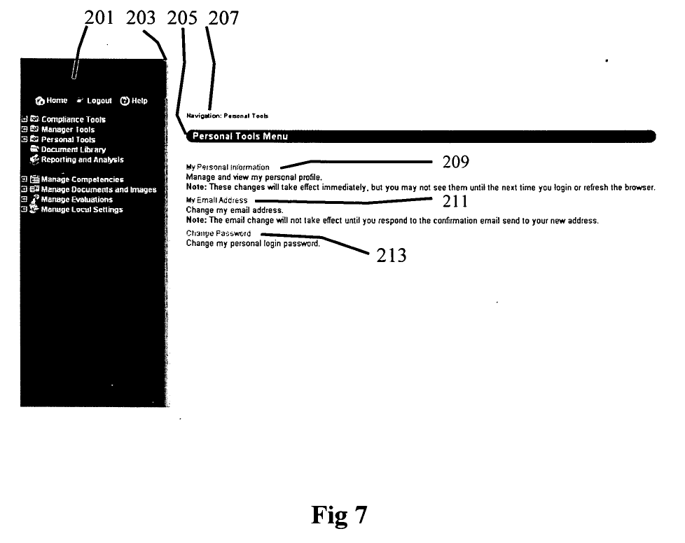

FIG. 7 shows a computer product interface of a 360 degree critical evaluator personal tools menu. A personal tools screen 203 is shown that is typically displayed when an operator selects personal tools. A bar 201 to the left displays navigation hot spots for operator navigation where an operator can select; home, logout, help, compliance tools, manager tools, personal tools, document library, reporting and analysis, manage users and profiles, manage competencies, manage documents and images, manage evaluations, and manage local settings. The screen 203 has a navigation history bar 207 for operator awareness and convenience. The screen 203 has a title bar 205 displaying the screen title “Personal Tools Menu”. A next hot spot 209 is labeled “My Personal information” where an operator can manage and view the operator's personal profile. The hot spot 209 also displays a note: “These changes will take affect immediately, but you may not see them until the next time you login or refresh the browser”. A next hot spot 211 is labeled “My Email Addresses” where an operator can change email address. The hot spot 211 also displays a note: “The email change will not take effect until you respond to the confirmation email send to your address”. A next hot spot 213 is labeled “Change Password” where an operator can change his or her personal login password.

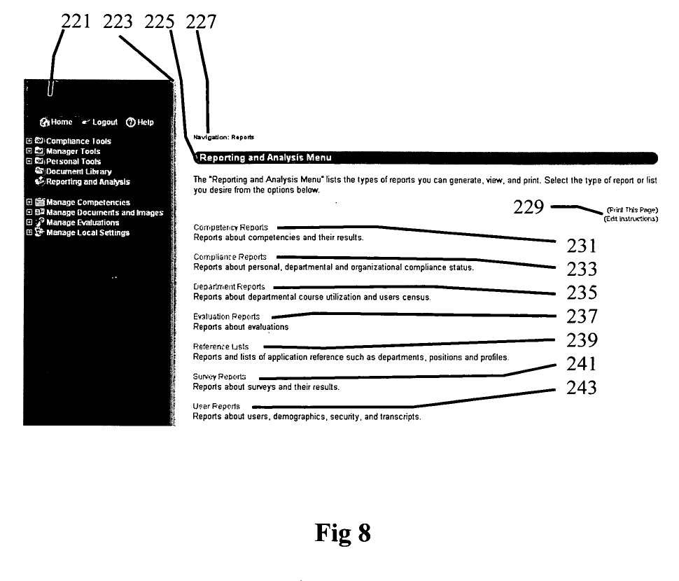

FIG. 8 shows a computer product interface of a 360 degree critical evaluator reporting and analysis menu. A reporting and analysis screen 223 is shown that is typically displayed when an operator selects reporting and analysis. A bar 221 to the left displays navigation hot spots for operator navigation where an operator can select; home, logout, help, compliance tools, manager tools, personal tools, document library, reporting and analysis, manage users and profiles, manage competencies, manage documents and images, manage evaluations, and manage local settings. The screen 223 has a navigation history bar 227 for operator awareness and convenience. The screen 223 has a title bar 225 displaying the screen title “Reporting and Analysis Menu”. This screen lists the types of reports and customizable templates an operator can generate, view, and print. These reports and templates facilitate with organization-defined standards and organization's critical evaluations through thorough and comprehensive data availability with repeatable data standards improving an organization's ability to obtain certification. Organization's can enjoy improved performance (over non-critical evaluator system users) with less management time. An operator can select the type of report, list, or template. A choice of feature hot spots 229 allows the operator to print the page of (if authorized) edit instructions. Contained in the following reports engine is the ability to include trend analysis and out of bound data collection to spot possible developments within an organization prior to a problem occurring. Additionally, these data can identify educational and professional developmental difficulties. Originally a hot spot 231 is labeled “Competency Reports” where an operator can view, generate, and template reports about competencies and their results. A next hot spot 233 is labeled “Compliance Reports” where an operator can view, generate and template reports about personal, departmental, and organizational compliance status. A next hot spot 235 is labeled “Department Reports” where an operator can view, generate, and template reports about departmental course utilization and users census. A next hot spot 237 is labeled “Evaluation Reports” where an operator can view, generate, and template reports about evaluations. A next hot spot 239 is labeled “Reference Lists” where an operator can view, generate and template reports and-lists of application reference such as departments, positions, and profiles. A next hot spot 241 is labeled “Survey Reports” where an operator can view, generate, and template reports about survey and their results. A next hot spot 243 is labeled “User Reports” where an operator can view, generate forms for input, operation, and assessment through templated reports about users, demographics, security, and transcripts.

FIG. 9 DELETED

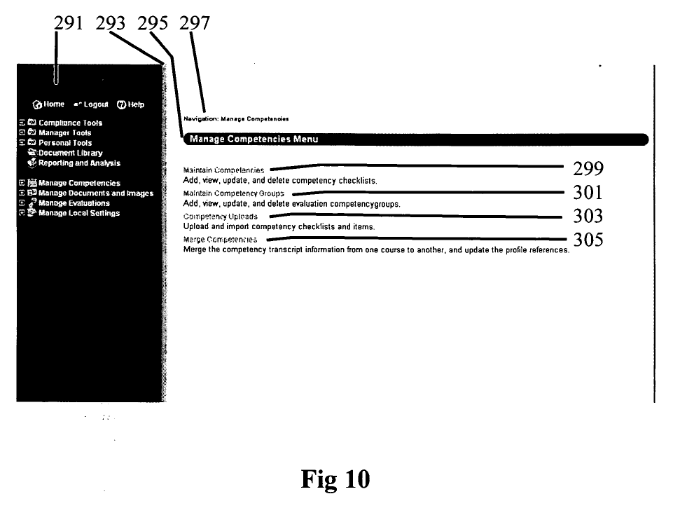

FIG. 10 shows a computer product interface of a 360 degree critical evaluator manage competencies menu. A manage competencies screen 293 is shown that is typically displayed when an operator selects manage competencies. A bar 291 to the left displays navigation hot spots for operator navigation where an operator can select; home, logout, help, compliance tools, manager tools, personal tools, document library, reporting and analysis, manage users and profiles, manage competencies, manage documents and images, manage evaluations, and manage local settings. The screen 293 has a navigation history bar 297 for operator awareness and convenience. The screen 293 has a title bar 295 displaying the screen title “Manage Competencies Menu”. Below the title bar 295 is a hot spot 299 labeled “Maintain Competencies” where an operator can add, view, update, and delete competency checklists. A next hot spot 301 labeled “Maintain Competency Groups” where an operator can create, add, view, update, and delete evaluation competency groups. A next hot spot 303 labeled “Competency Uploads” where an operator can upload and import competency checklists and items. A next hot spot 305 labeled “Merge Competencies” where an operator can merge the competency transcript information form one course to another, and update the profile references.

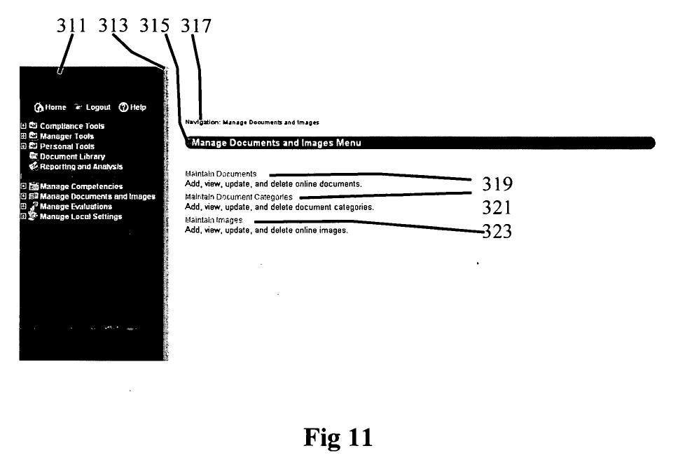

FIG. 11 shows a computer product interface of a 360 degree critical evaluator manage documents and images menu. A manage documents and images screen 313 is shown that is typically displayed when an operator selects manage documents and images. A bar 311 to the left displays navigation hot spots for operator navigation where an operator can select; home, logout, help, compliance tools, manager tools, personal tools, document library, reporting and analysis, manage users and profiles, manage competencies, manage documents and images, manage evaluations, and manage local settings. The screen 313 has a navigation history bar 317 for operator awareness and convenience. The screen 313 has a title bar 315 displaying the screen title “Manage Documents and Images Menu”. Below title bar 315 is a hot spot 319 labeled “Maintain Documents” where an operator can add, view, update, and delete online documents. A next hot spot 321 labeled “Maintain Document Categories” where an operator can add, view, update, and delete document categories. A next hot spot 323 labeled “Maintain Images” where an operator can add, view, update, and delete online images.

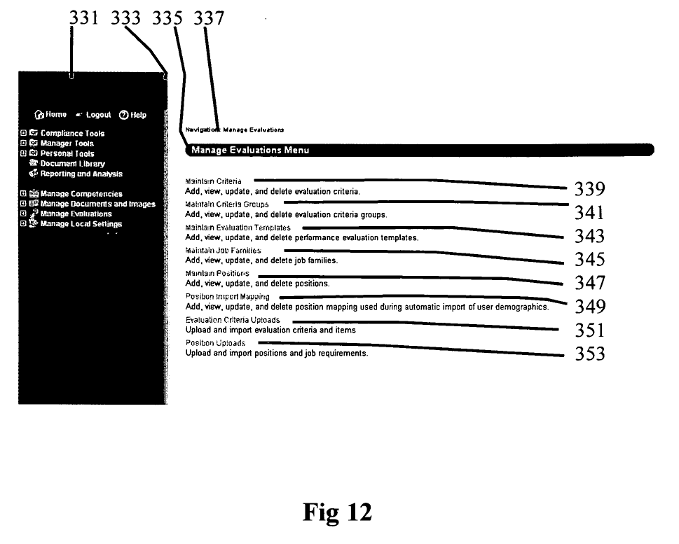

FIG. 12 shows a computer product interface of a 360 degree critical evaluator manage evaluations menu. A manage evaluations screen 333 is shown that is typically displayed when an operator selects manage evaluations. A bar 331 to the left displays navigation hot spots for operator navigation where an operator can select; home, logout, help, compliance tools, manager tools, personal tools, document library, reporting and analysis, manage users and profiles, manage competencies, manage documents and images, manage evaluations, and manage local settings. The screen 333 has a navigation history bar 337 for operator awareness and convenience. The screen 333 has a title bar 335 displaying the screen title “Manage Evaluations Menu”. Below title bar 335 are a collection of hot spot containing general and specific forms (screens) for managing critical evaluations. Forms can be defined and set as templates to standardize an organizations approach to critical evaluations. A standardized evaluation will improve an organization's consistency. The structure of the file access facilitates management by a matrix type operation. Specifically a responsible manager (manager of record) makes electronic selection on an electronic template-based evaluation form and maintains evaluation lead with inputs from other managers that a staff member may perform tasks for during an evaluation period. The inputs are typically directed by the organization and may be direct (with access) to records or submitted through the manager of record. Originally a hot spot 339 labeled “Maintain Criteria” where an operator can add, view, update, and delete evaluation criteria. A next hot spot 341 labeled “Maintain Criteria Groups” where an operator can add, view, update, and delete evaluation criteria groups.

A next hot spot 343 labeled “Maintain Evaluation Templates” where an operator can add, view, update, and delete performance evaluation templates. A next hot spot 345 labeled “Maintain Job Families” where an operator can add, view, update, and delete job families. A next hot spot 347 labeled “Maintain Positions” where an operator can add, view, update, and delete positions. A next hot spot 349 labeled “Position Import Mapping” where an operator can add, view, update, and delete position mapping used during automatic import of user demographics. A next hot spot 351 labeled “Evaluation Criteria Uploads” where an operator can upload and import evaluation criteria and items. A next hot spot 353 labeled “Position Updates” where an operator can upload and import positions and job requirements.

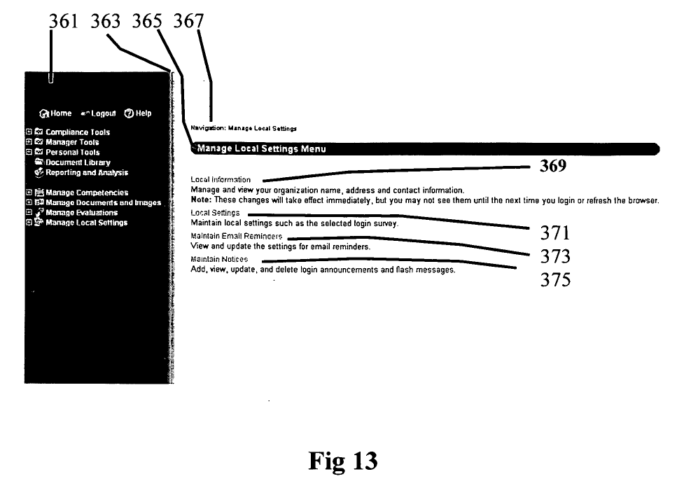

FIG. 13 shows a computer product interface of a 360 degree critical evaluator manage local settings menu. A manage local settings screen 363 is shown that is typically displayed when an operator selects manage local settings. A bar 361 to the left displays navigation hot spots for operator navigation where an operator can select; home, logout, help, compliance tools, manager tools, personal tools, document library, reporting and analysis, manage users and profiles, manage competencies, manage documents and images, manage evaluations, and manage local settings. The screen 363 has a navigation history bar 367 for operator awareness and convenience. The screen 363 has a title bar 365 displaying the screen title “Manage Local Settings Menu”. Below title bar 365 is a hot spot 369 labeled “Local information” where an operator can manage and view an operator's organization name, address, and contact information. Additionally, with hot spot 369 is a note that these changes take effect immediately, but will not be seen until the next login or by refreshing the browser. A next hot spot 371 labeled “Local Settings” where an operator can maintain local settings such as the selected login survey. A next hot spot 373 labeled “Maintain Email Reminders” where an operator can view and update settings for automated email reminders. Email reminders typically are staged to be sent by default at 60 days and 30 days before a test, recertification, or similar deadline is due, however through access hot spot 373 an operator can set the timing as desired in time line and frequency. A next hot spot 375 labeled “Maintain Notices” where an operator can add, view, update, and delete login announcements and flash messages.

### Operation

To operate the system and method for implementing a 360 degree critical evaluator an organization should open an account with the services provider as discussed in FIG. 1. When the services provider system administrator and the sponsoring organization's system administrator have established content, organizational roles, security, access privileges, and employee lists the individual employee's can log on to the evaluation screen. Referring to FIG. 3;

To access the system:
Open your internet browser and go to the web address provided,
Select your employer from the list of participating employers,
Enter you Login ID and password,
Click the “Login” button.

### General Navigation

Navigation is made simple in the system and method for implementing a 360 degree critical evaluator by use of a navigation bar at the top of each page. This navigation bar shows the user where they are in the system and the path they took to get there. The FIG. 3 navigation bar on the left shows the path an administrator took to get to the Associate User Profile page while setting up a new user.

On critical evaluator's computer interface screens pages where users must search for an item such as a specific user or course, users may quickly narrow the search by selecting the first character of the search criteria either above or below the search window. Letters or numbers that contain at least one item will be in red.

### DESCRIPTION OF THE PREFERRED EMBODIMENT(S)

In the preferred embodiment the system and method for implementing a 360 degree critical evaluator will be configured as depicted in FIG. 1 with computer support hardware as shown in FIG. 2. The user viewable computer product of the system and method for implementing a 360 degree critical evaluator will be represented by FIG. 3 with various navigation and display variations to accommodate user requirements. Although every permutation of the system and method for implementing a 360 degree critical evaluator has not been shown in this disclosure the representative figures should give the reader the understanding how the system and method for implementing a 360 degree critical evaluator improves an organization's handling of evaluation of compliance management.

What is claimed is:

1. A secure web-based employee performance evaluation and management system based on an organizations-defined standards for evaluating professional performance in an organization for regulatory requirements through an employee's comprehensive record of skills and abilities, customizable template-based evaluation form layouts, report forms, and feedback which comprises;
a networked computer system means,
a computer system storage means,
a computer entry interface means for an organizations' on-line and off-line employee performance evaluation, and management,
a means for manipulating on-line and off-line evaluation form formats to suit a specific organization,
a means for presenting organization evaluations and regulatory requirements compliance of organization-defined standards through summary record of compliance reports,
a means for including all aspects of the evaluated requirements in the employee assessment,
a means for providing a full cycle of evaluation process including manager, peer, employee, and organizational feedback,
a means for an organization to generate forms for input, operation, and assessment through templates,
a means for reporting providing operators with forms and final printed format that matches an organization's standards,
a means for assisting maintaining evaluations through automated email reminders,
a means for managing organizational performance consistency through trend analysis and out-of-bound exception reporting,
a means for managing delivery and tracking of employee performance, and identifying educational and professional development deficiencies.

2. The secure web-based employee performance evaluation and management system according to claim 1 wherein the computer system provides a virtual data processing means available to sponsoring organizations through minimal support system investment.

3. The secure web-based employee performance evaluation and management system according to claim 1 wherein the computer system storage provides virtual data storage means to subscribing organizations through minimal support system investment.

4. The secure web-based employee performance evaluation and management system according to claim 1 wherein the computer entry is facilitated through a web browser enabled terminal with minimal organizational support system investment.

5. The secure web-based employee performance evaluation and management system according to claim 1 wherein the manipulating on-line and off-line evaluation form formats to suit a specific organization means facilitates an organization set up and reuse for evaluation and compliance.

6. The secure web-based employee performance evaluation and management system according to claim 1 wherein the presenting summary reports of organization evaluations and regulatory requirements compliance through organization-defined standards means facilitates evaluators improving performance and compliance.

7. The secure web-based employee performance evaluation and management system according to claim 1 wherein the aspects of the evaluated requirements include; job knowledge, accomplishment of objectives, quality of work, productivity, initiative and creativity, interpersonal relationships, supervisory skills, dependability, and professional contribution means with a minimal managerial effort.

8. The secure web-based employee performance evaluation and management system according to claim 1 wherein the reporting means facilitates a managers' evaluation and compliance requirements implementation.

9. The secure web-based employee performance evaluation and management system according to claim 1 wherein the automated reminder means are implemented through the computer system means and delivered to an employee with a staged frequency.

10. The secure web-based employee performance evaluation and management system according to claim 1 wherein the trend analysis and out-of-bound exception reporting means facilitates a managers group performance awareness.

11. The secure web-based employee performance evaluation and management system according to claim 1 wherein the means for managing delivery and tracking of employee performance, and identifying educational and professional development deficiencies facilitates a manager of record for a department as lead for all employees in the department improving organization matrix management implementation.

12. A web-based method for accomplishing secure organizational performance evaluations based on an organization-defined standards for evaluating professional performance in an organization for reporting compliance to regulatory requirements through an employee's comprehensive record of skills and abilities, customizable template-based evaluation form layouts the method comprising;
storing at least one on-line or off-line employee performance evaluation in machine readable format,
interfacing by employees through computer terminals,
facilitating secure access of employee records to organizations over an internet connection,
providing assignment of varying levels of capabilities functionality to users within an organization,
transmitting to an organization at least one on-line or off-line employee record,
facilitating on-line and off-line organization modification of evaluation templates for local content supplementation,
establishing employee groupings in organizational roles for standardizing group evaluation requirements,
facilitating organizational manipulating of evaluation forms and report formats to comply to organizational requirements,
facilitating tracking of employee performance in proficiency of on-line and off-line evaluations,
archiving employee evaluations of on-line and off-line performance,
assisting in maintaining of evaluations through automated email reminders,
analyzing of employee evaluation performance consistency through trend analysis and out-of-bound exception reporting, and
implementing a 360 degree, full cycle of evaluation process including current input from a manager, peer, self, and organizational evaluation input.

13. The web-based method of accomplishing secure organizational performance evaluations of claim 12 wherein storing of employee records is accomplished through a virtual data repository.

14. The web-based method of accomplishing secure organizational performance evaluations of claim 12 wherein employee interfacing is accomplished through a web browser capable terminal.

15. The web-based method of accomplishing secure organizational performance evaluations of claim 12 wherein facilitating secure access of employee records allows an exchange of data and records throughout the organization.

16. The web-based method of accomplishing secure organizational performance evaluations of claim 12 wherein reporting of regulatory requirements are standardized in a template(s) for an organizations for ease of reference by employees providing a consistency for evaluators, certification requirements, and employees being evaluated.

17. The web-based method of accomplishing secure organizational performance evaluations of claim 12 wherein establishing employee groupings facilitates a standard of evaluation for the organization's compliance efforts.

18. The web-based method of accomplishing secure organizational performance evaluations of claim 12 wherein the presenting of a summary record of compliance of an organization evaluations and regulatory requirements compliance through organization-defined standards facilitates evaluators improves the organization's performance and compliance.

19. The web-based method of accomplishing secure organizational performance evaluations of claim 12 wherein facilitating tracking employee performance proficiency on-line and off-line provides a streamlined availability and improved usage.

20. The web-based method of accomplishing secure organizational performance evaluations of claim 12 wherein archiving employee evaluations provides a simplified access and reference for future evaluations and compliance requirements.

21. The web-based method of accomplishing secure organizational performance evaluations of claim 12 wherein assisting evaluation compliance is improved with a staged lead time email notifications.

22. The web-based method of accomplishing secure organizational performance evaluations of claim 12 wherein storing an organization's standardized templates provides a consistent and repeatable evaluation of employees.

23. The web-based method of accomplishing secure organizational performance evaluations of claim 12 wherein implementing the 360 degree, full cycle of evaluation provides a simple to use process that encompasses the entire organization.

24. The web-based method of accomplishing secure organizational performance evaluations of claim 12 wherein analyzing of employee evaluation performance consistency through trend analysis and out-of-bound exception reporting provides managers with preemptive alerts to potential problems.

25. A web-based computer program product stored in a computer record for creating a selectable on-line and off-line evaluation and compliance to requirements with secure content delivery, templates, forms, reports, and analysis program code for employee evaluations, organizational compliance and summary record reporting of compliance to accrediting bodies by an organization or institution.
